(19) United States
(12) Patent Application Publication
(10) Pub. No.: US 2025/0175289 A1
(43) Pub. Date: May 29, 2025

(54) CODEWORD-BASED RANDOM ACCESS CHANNEL COMMUNICATIONS

(71) Applicant: QUALCOMM Incorporated, San Diego, CA (US)

(72) Inventors: Ayan SENGUPTA, San Diego, CA (US); Alberto RICO ALVARINO, San Diego, CA (US); Syed Hashim Ali SHAH, San Diego, CA (US)

(21) Appl. No.: 18/899,752

(22) Filed: Sep. 27, 2024

Related U.S. Application Data
(60) Provisional application No. 63/603,985, filed on Nov. 29, 2023.

(51) Int. Cl. H04L 5/00; H04W 74/0833

(52) U.S. Cl. CPC H04L 5/0012; H04W 74/0833

(57) ABSTRACT

Certain aspects of the present disclosure provide techniques for codeword-based random access channel (RACH) communications. A method for wireless communications by an apparatus includes sending a first signal in one or more time-frequency resources associated with a RACH, wherein the first signal is multiplexed using a first codeword, the one or more time-frequency resources and the first codeword defining a preamble signature; receiving a random access response (RAR) associated with the preamble signature; and communicating with a network entity in response to receiving the RAR.

### CROSS-REFERENCE TO RELATED APPLICATION(S)

The present application for patent claims benefit of U.S. Provisional Application No. 63/603,985, filed Nov. 29, 2023, which is hereby expressly incorporated by reference herein in its entirety.

### INTRODUCTION

### Field of the Disclosure

Aspects of the present disclosure relate to wireless communications, and more particularly, to techniques for random access communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus (e.g., a user equipment). The method includes sending a first signal in one or more time-frequency resources associated with a random access channel (RACH), wherein the first signal is multiplexed using a first codeword, the one or more time-frequency resources and the first codeword defining a preamble signature; receiving a random access response (RAR) associated with the preamble signature; and communicating with a network entity in response to receiving the RAR.

Another aspect provides a method for wireless communications by an apparatus (e.g., a network entity). The method includes obtaining a first signal in one or more time-frequency resources associated with a RACH, wherein the first signal is multiplexed using a first codeword, the one or more time-frequency resources and the first codeword defining a preamble signature; sending a RAR associated with the preamble signature; and communicating with a user equipment in response to sending the RAR.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A is an example process flow diagram illustrating an example four-step random access procedure performed between a UE and a network entity.

FIG. 5B is an example process flow diagram illustrating an example two-step random access procedure performed between a UE and a network entity.

FIG. 6 is a diagram illustrating an example narrowband physical random access channel resource grid using code division multiplexing for a random access preamble transmission.

FIG. 7 is a diagram of an example arrangement for random access channel (RACH) resources.

FIG. 8 is a diagram illustrating an example medium access control protocol data unit for communicating one or more random access responses (RARs) to one or more UEs.

FIG. 9A is a diagram illustrating an example random access preamble identifier (RAPID) subheader.

FIG. 9B is a diagram illustrating an example RAR payload.

FIG. 9C is a diagram illustrating an example backoff subheader.

FIG. 10 is a diagram illustrating an example RAR payload indicating a codeword for a MSG3 transmission.

FIG. 11 depicts a process flow for communications in a network between a UE and a network entity.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for codeword-based random access channel (RACH) communications.

Certain wireless communications (e.g., Narrowband Internet of Things (NB-IoT) communications for Evolved Universal Terrestrial Radio Access (E-UTRA) systems and/or 5G New Radio (NR) systems) may use a specified set of resources for random access to the radio access network (RAN). For example, NB-IoT devices may be allocated a certain number of subcarriers in a narrowband physical random access channel (NPRACH) to randomly select for random access to the RAN. In certain aspects, where the RAN is discussed herein as performing one or more operations, such operation(s) may be performed by one or more network entities (e.g., a base station and/or a disaggregated entity thereof) of the RAN.

Technical problems for narrowband communications may include, for example, providing sufficient capacity for random access communications. As the number of deployed NB-IoT devices increases in a RAN (e.g., with the increased adoption of IoT devices in communication with a wireless wide area network (WWAN)), there may be an increased likelihood of NB-IoT devices using the same subcarrier for random access. In such cases, where multiple NB-IoT devices are transmitting via the same subcarrier for random access, the RAN may be unable to decode certain random access transmissions (e.g., a RACH preamble or a MSG3 transmission) from the NB-IoT devices and respond to such transmissions. As such, an NB-IoT device may perform multiple RACH attempts to establish a communication link with the RAN. Accordingly, the RACH attempts may use a non-trivial amount of time and contribute to the latency encountered by the NB-IoT to establish the communication link.

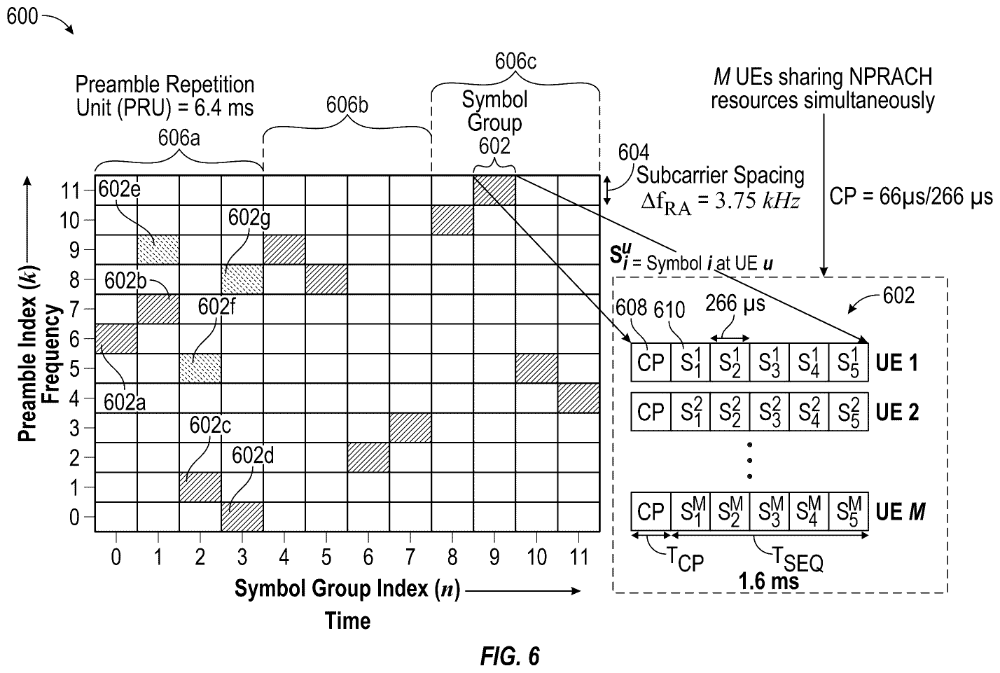

Certain aspects of the present disclosure may overcome the aforementioned technical problem(s), for example, by providing for frequency hopping, codeword-based physical uplink shared channel (PUSCH) (e.g., MSG3) transmissions, configuration levels, and subsequent RACH transmissions associated with codeword-based RACH communications. Codeword-based RACH communications may use code division multiplexing (e.g., an orthogonal covercode (OCC)) to increase the resources available for RACH communications, for example, as further described herein with respect to FIG. 6. In certain aspects, the codeword-based RACH communications may apply a frequency hopping pattern based on the codeword. In certain aspects, code division multiplexing may be applied to a MSG3 transmission in a random access procedure. In certain aspects, the codeword-based RACH communications may be configured via common configuration and/or carrier-specific configuration. In certain aspects, retransmissions of a preamble may use a specific codeword (e.g., a randomly selected codeword) for the retransmission.

The techniques for codeword-based random access communications described herein may provide various technical effects and/or advantages. For example, the codeword-based random access communications described herein may improve wireless communication performance including, for example, an increased throughput, decreased latency, and/or increased random access channel capacity. The improved performance may be attributable to codeword-based random access communications. As an example, the frequency hopping described herein may reduce the likelihood of codeword-based RACH transmissions sharing the same subcarrier frequency hopping pattern, and thus, interference from the codeword-based RACH transmissions may be reduced. Codeword-based MSG3 transmissions may increase the resources available for MSG3 transmissions. Carrier-specific configurations may allow a RAN operator/controller to tailor the settings associated with codeword-based random access communications to the traffic patterns and/or conditions of a particular cell site.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

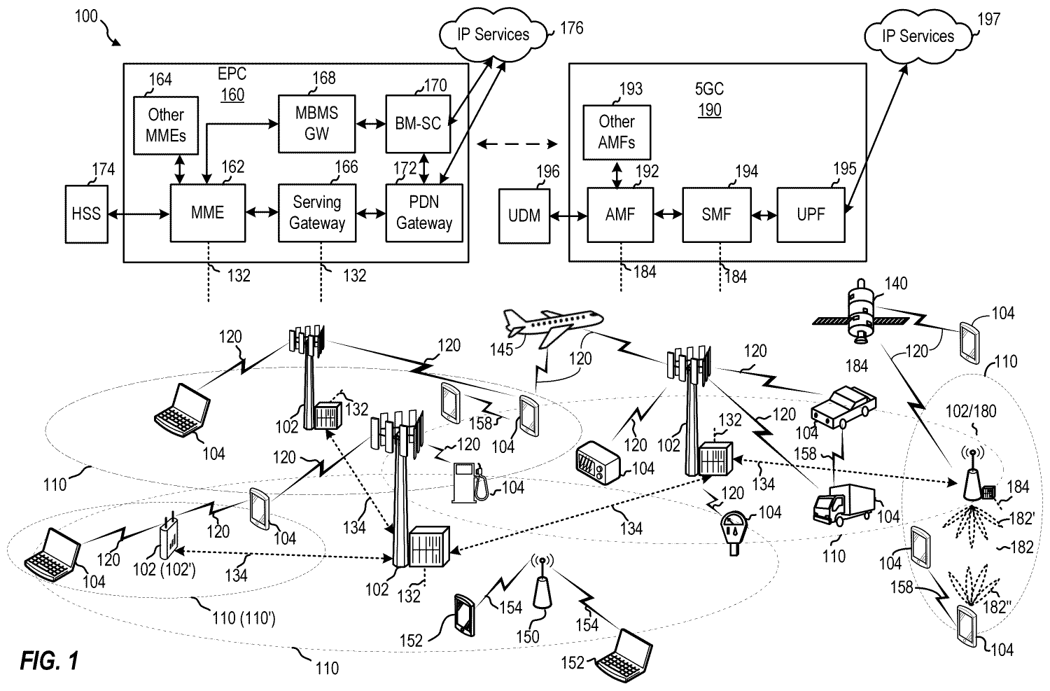

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

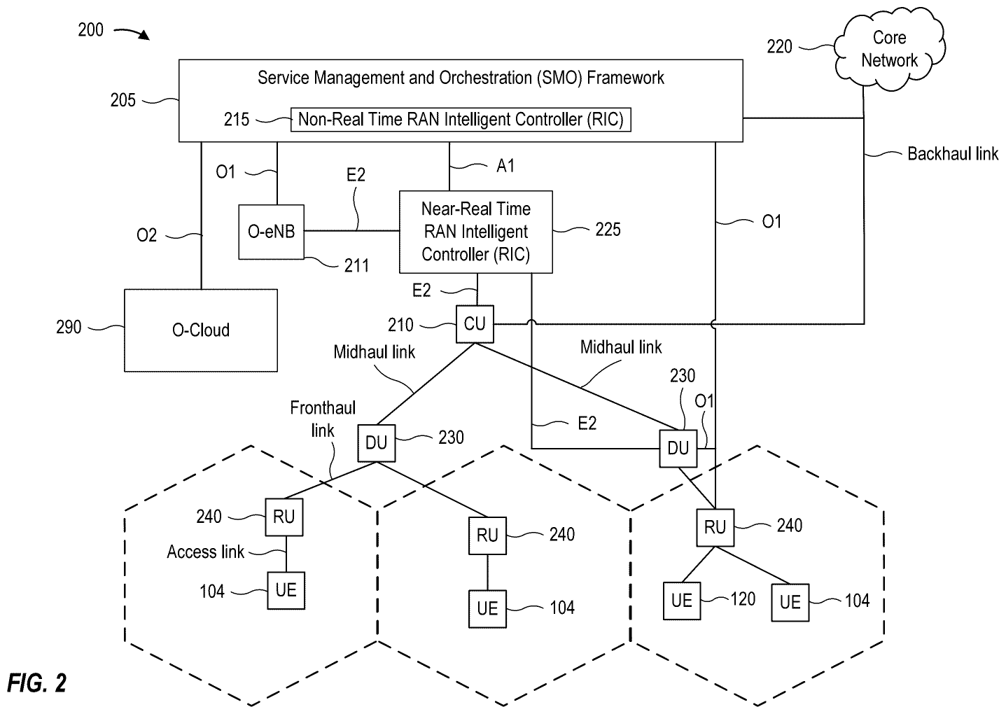

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

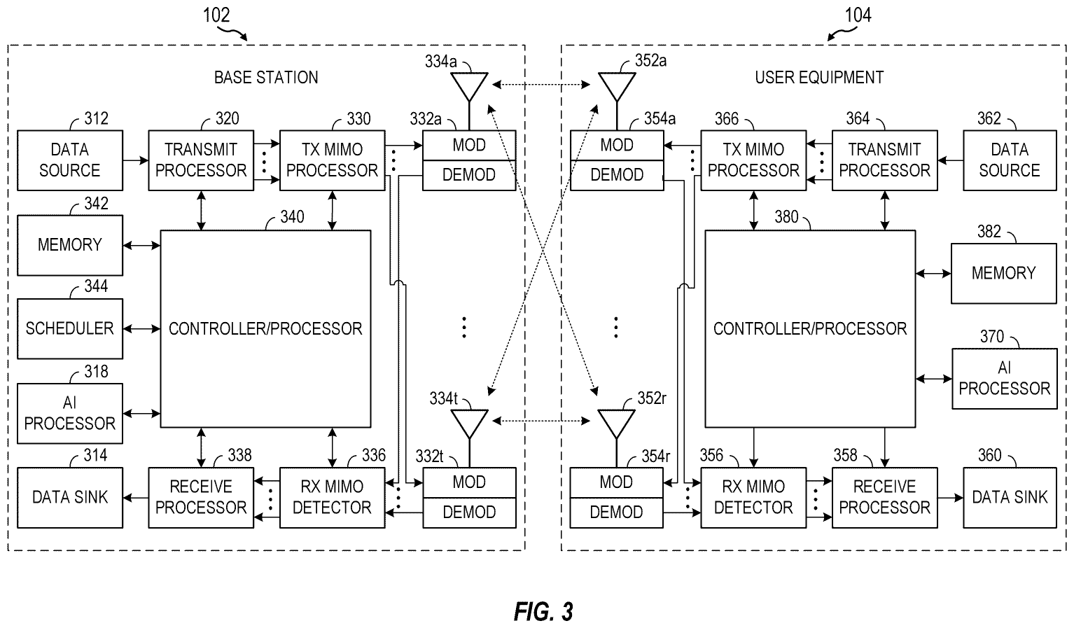

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

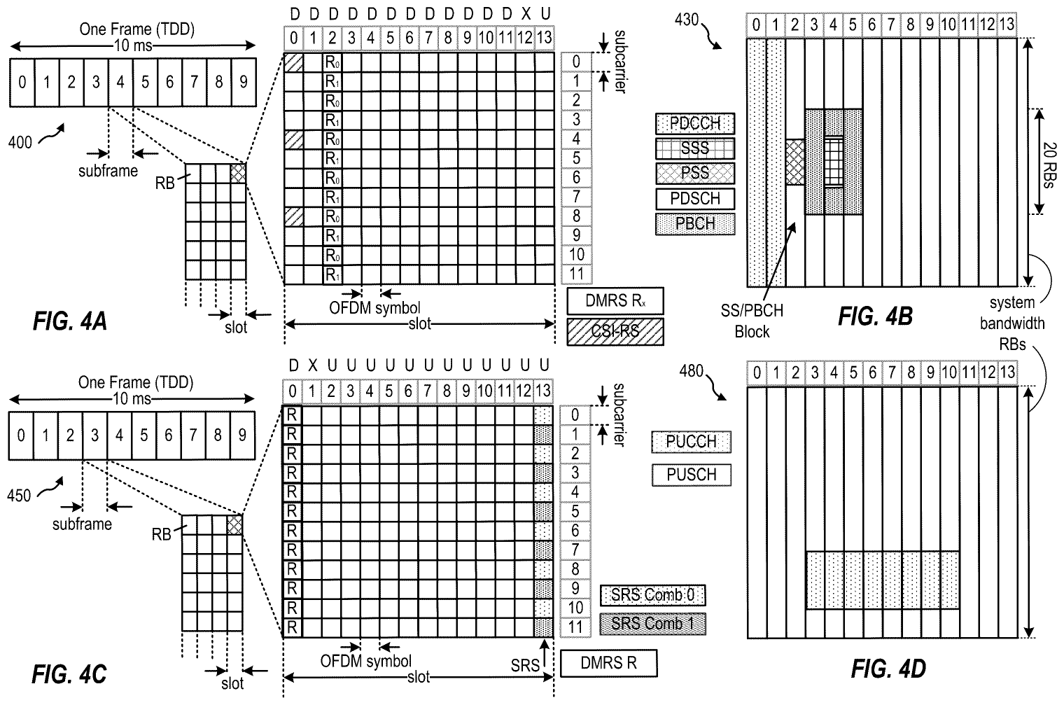

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., an E-UTRA system and/or 5G NR system) may provide a specified channel for random access, such as a random access channel (RACH), and corresponding random access procedures. A UE may use the RACH for initial access to a RAN, for example. A random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

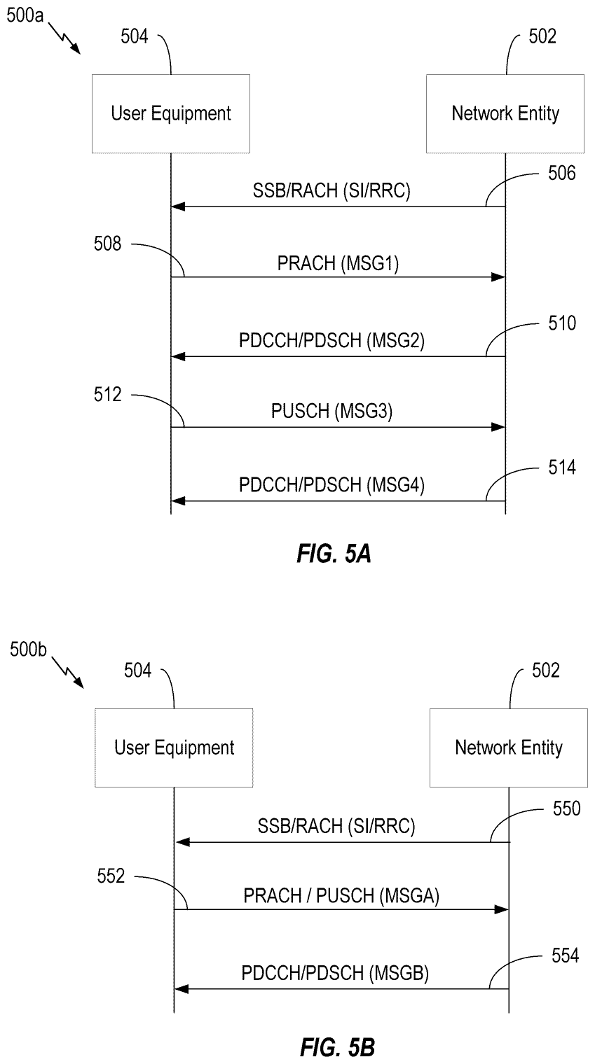

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may optionally begin at 506, where the network entity 502 broadcasts and the UE 504 receives a random access configuration, for example, in system information within a synchronization signal block (SSB), or within an RRC message. The random access configuration may indicate or include one or more parameters for random access communications, such as defining the RACH, the number of random access preambles (e.g., preamble sequences) available for random access, power ramping parameters, response window size, etc.

At 508, the UE 504 sends a first message (MSG1) to the network entity 502 on a physical random access channel (PRACH). In some aspects, MSG1 may indicate or include a RACH preamble. The RACH preamble may indicate or include a preamble signature associated with the RACH preamble. The preamble signature may correspond to a particular preamble sequence (e.g., a Zaddoff Chu sequence) generated across time-frequency resources used for the preamble transmission. For contention-based random access, the preamble sequence may be randomly selected among a set of preamble sequences (e.g., up to 64 sequences in some cases). The preamble signature may be used to identify the UE 504 for scheduling communications (e.g., MSG2 and MSG3) with the network entity. The term “RACH preamble” may refer to or correspond to “random access preamble,” “preamble,” “preamble sequence,” and/or “preamble signature.”

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and a backoff parameter value. The RAPID may correspond to the preamble signature and indicate that the RAR is for the UE 504 that transmitted MSG1 at 506. As an example, the RAPID may identify a particular frequency resource used for the preamble transmission. As further described herein, the backoff parameter value may be used to determine a RACH occasion for sending a subsequent RACH transmission (e.g., a preamble transmission). A RACH occasion may correspond to one or more time resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 may use the time-frequency resource(s) indicated in the UL grant of the RAR.

At 514, the network entity 502 may send a contention resolution message (MSG4) in response to MSG3. The network entity 502 may send a downlink scheduling command (e.g., DCI), which is addressed to a specific UE identity associated with the UE 504 as discussed below, via the PDCCH. The network entity 502 may send a UE contention resolution identity (e.g., a medium access control element) via the PDSCH according to the downlink scheduling command. In certain cases, multiple UEs may send the same preamble in the same random access occasion. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity 502 was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to receive or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the RACH, and the payload of MSGA may be transmitted over the PUSCH, for example.

At 554, the network entity 502 may send a random access response message (MSGB), which may effectively combine MSG2 and MSG4 described above. For example, MSGB may include a RAPID, a timing advance, a backoff parameter value, a contention resolution message, an uplink and/or downlink grant, and transmit power control commands.

### Example NB-IoT Communications

Certain wireless communication systems (e.g., an E-UTRA system and/or 5G NR system) may enable access to network services using a physical layer configured for very low power consumption and low complexity, which may be beneficial for Internet-of-Things (IoT) devices operating on battery power or power harvesting circuitry. These low power network services may be referred to as narrowband IoT (NB-IoT) communications. For NB-IoT communications, a UE may be capable of data rates up to 68 kbps for downlink and up to 132 kbps for uplink, for example, via a full carrier bandwidth of 180-200 kHz and a subcarrier spacing of 3.75 kHz or 15 kHz. At such a low bandwidth, the NB-IoT device may support a low complexity transceiver to enable a low cost solution for IoT devices. In certain cases, a UE may be equipped with only a single antenna to facilitate the low power consumption. The low power consumption may enable an NB-IoT device to operate for at least 10 years on battery power or almost indefinitely with power harvesting. Those of skill in the art will understand that the specification associated NB-IoT communications (e.g., the data rates, carrier bandwidth, and/or subcarrier spacing) are merely examples. Other specifications may be used in addition to or instead of those described.

NB-IoT communications may use a specified set of resources (e.g., RACH subcarriers) for random access to the RAN. For example, NB-IoT devices may be allocated up to 48 subcarriers in a NPRACH to select for random access to the RAN. As the number of deployed NB-IoT devices increases in a RAN (e.g., with the increased adoption of wirelessly connected IoT devices), there may be an increased likelihood of NB-IoT devices using the same subcarrier for random access. In such cases, where multiple NB-IoT devices are transmitting via the same subcarrier for random access, the RAN may be unable to decode certain random access transmissions (e.g., a MSG1 transmission or a MSG3 transmission) from the NB-IoT devices and respond to such transmissions, for example, due to inference between the overlapping transmissions from multiple NB-IoT devices. As such, NB-IoT devices may send an increased number of RACH attempts to establish a communication link with the RAN, which may result in an increased latency to establish a communication link with the RAN. As the random access procedure is used for various of events, the performance of the random access procedure affects the performance of a variety of wireless communication activities, such as initial access, handover, UL/DL data arrival, etc.

### Aspects Related to Codeword-Based RACH Communications

Aspects of the present disclosure provide for frequency hopping, codeword-based MSG3 transmissions, configuration levels, and subsequent RACH transmissions associated with codeword-based RACH or random access communications. Codeword-based RACH communications may include codeword-based RACH communications (e.g., MSG1) and/or codeword-based random access communications (e.g., MSG2, MSG3, and/or MSG4). In certain aspects, the codeword-based RACH communications may apply a frequency hopping pattern based on the codeword. For example, a frequency hopping formula, which is used to randomly generate the frequency hopping pattern, may include a codeword parameter that affects the frequency hopping applied to a random access transmission (e.g., the preamble). In certain aspects, code division multiplexing may be applied to a MSG3 transmission in a random access procedure, and the RAR may indicate or include such a codeword for the MSG3 transmission. For example, the RAR may indicate the MSG3 codeword in a RAR payload that supports codeword-based preambles and other types of preambles. In certain aspects, the codeword-based RACH communications may be configured via common configuration and/or carrier-specific configuration, for example, via RRC signaling and/or system information. For example, the RAN may configure a UE with common codeword-based RACH settings that apply to all carriers of a cell group, and the RAN may modify the common settings via carrier-specific settings. In certain aspects, retransmissions of a preamble may use a specific codeword for the retransmission. For example, the UE may use the same codeword as an initial preamble transmission, a different codeword, or a randomly selected codeword for a subsequent RACH transmission. Reference to a RAN performing certain operations, as discussed herein, may refer to one or more network entities (e.g., a base station) performing said operations.

The techniques for codeword-based random access communications described herein may provide various technical effects and/or advantages. For example, the codeword-based random access communications described herein may improve wireless communication performance including, for example, an increased throughput, decreased latency, increased number of devices (e.g., NB-IoT devices) that can access a RACH, increased resources available for random access, etc. The improved performance may be attributable to codeword-based RACH communications. As an example, the frequency hopping described herein may reduce the likelihood of codeword-based RACH transmissions sharing the same subcarrier frequency hopping pattern, and thus, interference from the codeword-based RACH transmissions may be reduced. Codeword-based MSG3 transmissions may increase the resources available for MSG3 transmissions. Carrier-specific configurations may allow a RAN operator/controller to tailor the settings associated with codeword-based random access communications to the traffic patterns and/or conditions of a particular cell site.

FIG. 6 is a diagram illustrating an example NPRACH resource grid 600 using code division multiplexing for a random access preamble transmission (e.g., MSG1). In this example, the NPRACH resource grid 600 may include a set of one or more symbol groups 602 arranged across a set of one or more subcarriers 604, which may have a subcarrier spacing of 3.75 kHz (or 15 kHz), for example. As shown, the symbol groups 602 may correspond to symbol group indices (n), and the subcarriers 604 may correspond to preamble indices (k) in the NPRACH resource grid 600. In some cases, the subcarriers 604 may include a contiguous set of subcarriers and a contiguous set of symbol groups. The NPRACH resource grid 600 may correspond to one or more NPRACH resources. In some cases, the NPRACH resource grid 600 may include a certain number of subcarriers, e.g., up to 48 subcarriers.

A random access preamble (e.g., MSG1) may include a sequence of symbol groups 602 (e.g., symbol groups 602a-d). In some cases, the random access preamble may be transmitted with repetition, for example, to enhance the reliability of the preamble transmission and/or enhance the coverage area (e.g., transmission range). As an example, a random access preamble may include one or more preamble repetition units (PRUs) 606a-c, and a PRU (e.g., the first PRU 606a) may include a sequence of one or more symbol groups 602 (e.g., the symbol groups 602a-d in the first PRU 606a). Each PRU may correspond to an instance (also referred to as repetition) of the random access preamble. The random access preamble having P symbol groups may be transmitted Nᵣₑₚ^{NPRACH} times.

A symbol group 602 may include a cyclic prefix (CP) 608 of length Top (e.g., 66 us or 266 μs) and a sequence of N symbols 610 with total length SEQ (e.g., symbol duration=266 μs). With code division multiplexing (e.g., applying M orthogonal cover codes (OCCs) to a symbol group), M codeword-based symbol groups (e.g., M-codeword-based signals having a length of the symbol group) may be able to share the same time-frequency resource (e.g., the same subcarrier in the same symbol group index). For example, a particular codeword may be used to form a baseband signal of a preamble transmission associated with the symbol group 602. Accordingly, the time-frequency resources and the codeword may be used to define or form a preamble signature associated with the preamble transmission, and the preamble signature may be used to identify the preamble transmission of a UE. The codeword-based symbol groups may allow multiple UEs to transmit on the same NPRACH resources, and thus, the number of UEs that can perform random access at the same time without collision on the NPRACH resources for random access may be proportionally increased by the number of codewords used for code division multiplexing. Such an increase in for the number of UEs that can perform random access without collision may alleviate channel congestion as more NB-IoT devices are deployed in the network.

In some cases, the random access preamble may include a sequence of subcarrier frequency-hopping symbol groups 602. As an example, the first PRU 606a may include a first symbol group 602a, a second symbol group 602b, a third symbol group 602c, and a fourth symbol group 602d arranged in symbol group indices 0-3, respectively. According to an example frequency hopping pattern, the first symbol group 602a is arranged in the subcarrier corresponding to preamble index 6; the second symbol group 602b is arranged in the subcarrier corresponding to preamble index 7; the third symbol group 602c is arranged in the subcarrier corresponding to preamble index 1; and the fourth symbol group 602d arranged in the subcarrier corresponding to preamble index 0. Likewise, the symbol groups associated with the second PRU 606b and the third PRU 606c may be arranged in the subcarriers of the NPRACH resource grid 600 according to the frequency hopping pattern.

In certain aspects, each of the PRUs 606a-c may be arranged in different subcarriers per the frequency hopping pattern. In some cases, the frequency hopping pattern may be defined relative to the start subcarrier for the preamble transmission, as in the start subcarrier of the first PRU in time of the preamble transmission. For example, if multiple UEs select the same start subcarrier for the preamble transmission (e.g., preamble index 6), the frequency hopping pattern may result in overlapping preamble transmissions that use the same frequency resources.

An example NPRACH configuration (e.g., provided by RRC signaling and/or system information) may include an NPRACH resource periodicity N_{period}^{NPRACH} (nprach-V period Periodicity)—for example, the periodicity for the NPRACH, a frequency location of the first subcarrier allocated to NPRACH N_{scoffset}^{NPRACH} (nprach-SubcarrierOffset), a number of subcarriers allocated to N_{sc}^{NPRACH} (nprach-NumSubcarriers), a number of starting subcarriers allocated to UE initiated random access N_{sc_cont}^{NPRACH} (nprach-NumCBRA-StartSubcarriers)—for example, the number of subcarriers allocated for CBRA, a number of NPRACH repetitions per attempt Nᵣₑₚ^{NPRACH} (numRepetitionsPerPreambleAttempt), NPRACH starting time Nₛₜₐᵣₜ^{NPRACH} start (nprach-StartTime), and/or a fraction for calculating starting subcarrier index for the range of NPRACH subcarriers reserved for indication of UE support for multi-tone MSG3 transmission N_{MSG3}^{NPRACH} (nprach-SubcarrierMSG3-RangeStart).

In certain aspects, the RAN may send a RAR transmission as a data block (e.g., one or more transport blocks), which may include a MAC protocol data unit (PDU), in time-frequency resource(s) (e.g., PDSCH). The MAC PDU may carry one or more RARs, where each of the RARs may be associated with a given preamble transmission as further described herein.

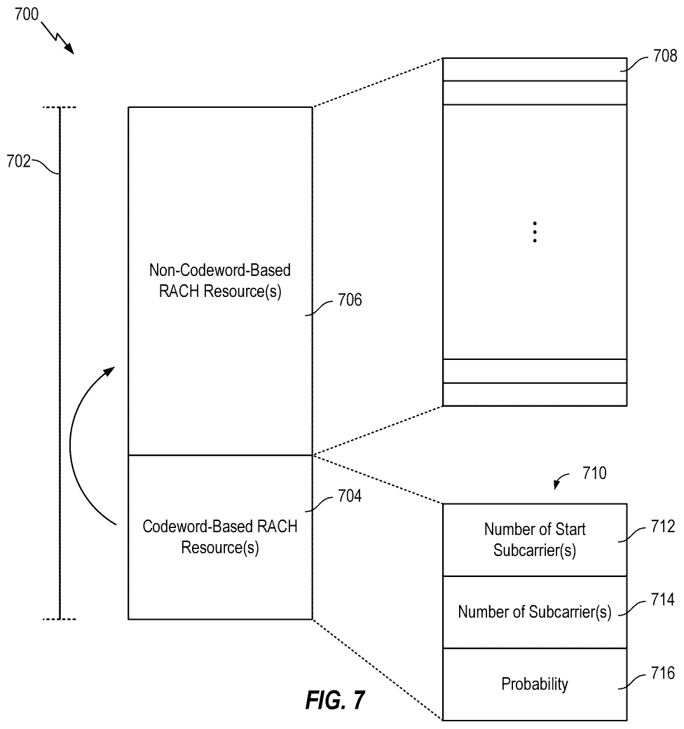

FIG. 7 is a diagram of an example arrangement for RACH resources 700 (e.g., NPRACH resources). In this example, the RACH resources 700 may be arranged across a frequency bandwidth 702, for example, a channel bandwidth assigned to the RACH. In some cases, the frequency bandwidth may be or include a carrier bandwidth (or any subdivision of a channel or carrier, such as a bandwidth part or a portion thereof). The RACH resources 700 may include one or more first resources 704 and one or more second resources 706. In some cases, each of the first and second resource(s) 704, 706 may include one or more subcarriers 708, such as the subcarriers corresponding to preamble indices as described herein with respect to FIG. 6. Those of skill in the art will appreciate that the one or more first resources 704 and the one or more second resources 706 are depicted as being adjacent to each other in the frequency domain (e.g., forming a contiguous block of frequency resources) to facilitate an understanding. Aspects of the present disclosure may apply to a frequency band being arranged between the one or more first resources 704 and the one or more second resources 706.

In certain aspects, NPRACH resource(s) for codeword-based random access communications may be separated from NPRACH resource(s) for other types of random access communications (e.g., non-codeword-based random access). For example, a first set of NPRACH resource(s) may be allocated for codeword-based random access, and a second set of NPRACH resource(s) may be allocated for other types of random access, where the first set of NPRACH resource(s) do not overlap with the second set of NPRACH resource(s). With respect to FIG. 7, the one or more first resources 704 may be dedicated to (e.g., reserved for) codeword-based RACH communications, and the one or more second resources 706 may be dedicated to non-codeword-based RACH communications. For example, UEs that support codeword-based RACH communications may not be allowed to use the one or more second resources 706 for codeword-based RACH communications, and UEs that do not support codeword-based RACH communication may not be allowed to use the one or more first resources 704 for non-codeword based RACH communications. A partition between the one or more first resources 704 and the one or more second resources 706 may prevent preamble collisions between OCC-capable and OCC-incapable UEs. Within the OCC-partition (e.g., the one or more first resources 704), OCC-capable UEs may use a particular OCC-codeword, which is equivalent to non-codeword-based communications, without colliding with non-codeword-based communications.

In certain aspects, a configuration 710 may specify certain characteristics associated with the RACH resources 700. The configuration 710 may indicate or include a (total) number of start subcarriers 712, a (total) number of subcarriers 714, and/or a probability 716 (as further described herein) associated with the one or more first resources 704. The number of start subcarriers 712 and the number of subcarriers 714 may be used to define the frequency location of the one or more first resources 704.

The configuration 710 may be specific to codeword-based RACH communications. For example, control signaling (e.g., system information and/or RRC signaling) may include an nprach-NumCBRAStartSubcarriers-withOCC field that indicates the value for the number of start subcarriers 712, and nprach-NumSubcarriers-OCC field that indicates the value for the number of subcarriers 714. The fields may be arranged in an information element (IE), such as NPRACH-ParametersList-NB-rXX-OCC. The IE may indicate or include other parameters (associated with a carrier) for the OCC-enabled resources (e.g., repetitions, number of subcarriers, etc.). For example, any of the fields associated with the example NPRACH configuration described above may be codeword-specific fields.

The number of start subcarriers 712 may indicate the portion of the one or more first resources 704 that can be used for codeword-based CBRA (e.g., the number of start subcarriers allocated to UE initiated random access), whereas the number of subcarriers 714 may indicate the total number of subcarriers 708 allocated for codeword-based RACH communications (e.g., CBRA and CFRA), for example, a frequency bandwidth (or frequency size) for the one or more first resources 704 in terms of subcarriers 708.

In certain aspects, the UEs that support codeword-based RACH communications may be allowed to use the one or more second resources 706 for RACH communications. A soft partition may be used between the one or more first resources 704 and the one or more second resources 706, and OCC-capable UEs may be configured with a statistically defined probability. For example, a probability (e.g., a probability distribution) may be specified for the codeword-capable UEs to use for randomly selecting one or more of the subcarriers 708 within the one or more second resources 706 for codeword-based RACH communications. The probability 716 may indicate a weight or ceiling for determining the probability, for example. Certain weights or probability values may be included in the OCC IE, where the weights or probability values may determine the probability distribution to be used for accessing resources in the OCC-incapable partition (e.g., the one or more second resources 706). In certain cases, the probability 716 may be specific to certain carrier(s) (e.g., NB-IoT carrier(s)). In some cases, the probability 716 for early data transmission (EDT) RA resources may be different for non-EDT RA resources.

A UE may randomly select one or more of the one or more second resources 706 according to a probability distribution that may be configured based on the probability 716. The UE may select a resource among the one or more first resources 704 and the one or more second resources 706 using a weighted probability for selecting the one or more second resources 706. For example, the UE may be configured to select the one or more second resources 706 with a probability of 20% using a pseudorandom function. As examples, a probability of 0% may indicate to refrain from using the one or more second resources 706 for codeword-based RACH communications, whereas a probability of 100% may indicate to refrain from using the one or more first resources 704 for codeword-based RACH communications.

In some aspects, the UEs that support codeword-based RACH communications may be allowed to use any of the RACH resources 700 for codeword-based RACH communications, likewise for UEs that do not support codeword-based RACH communications. For example, non-OCC-capable and OCC-capable UEs may be allowed to share all of the NPRACH resources. In certain aspects, the OCC-capable UEs may not be allowed to use a particular codeword for codeword-based RACH communications, such as the codeword (e.g., a codeword having all ones in binary) that is equivalent to non-codeword-based RACH communications. For example, the OCC-capable UEs may receive a configuration indicating one or more values to exclude from using as a codeword (e.g., the codeword having all ones in binary). In some cases, the OCC-capable UEs may be allowed or disallowed from using the codeword (e.g., the codeword having all ones in binary) that is equivalent to non-codeword-based RACH communications based on a probability. For example, the OCC-capable UEs may receive a configuration indicating a probability for selecting one or more values for the codeword, where the value(s) may include the codeword having all ones in binary or any other value. In certain cases, the probability may be specific to certain carrier(s) (e.g., NB-IoT carrier(s)). In some cases, the probability for EDT RA resources may be different for non-EDT RA resources.

### Example Frequency Hopping

In certain aspects, the codeword-based RACH communications may apply a frequency hopping pattern based on a codeword used for a RACH transmission. The codeword-based frequency hopping pattern may allow codeword-based preamble transmissions to be randomly distributed across the subcarriers. In some cases, pseudorandom frequency hopping may be applied to determine the subcarrier indices used in each PRU, where the frequency hopping may be based on the OCC used for communicating the preamble (e.g., used for communicating the preamble on the start subcarrier index). As an example with respect to FIG. 6, in the first PRU 606a, using a codeword-based frequency hopping pattern, a first UE that selects the start subcarrier index for the first symbol group 602a may follow a frequency hopping pattern based on a first codeword as previously described (e.g., the frequency pattern for symbol groups 602a-d), whereas a second UE that selects the same start subcarrier index for the first symbol group 602 may follow a different frequency hopping pattern based on a second codeword. The second codeword frequency hopping pattern may be arranged as depicted for the symbol groups 602a, 602e, 602f, and 602g. Thus, the codeword-based frequency hopping may allow further interference mitigation.

A frequency hopping formula may be used to determine the frequency hopping pattern associated with a RACH transmission. As an example, frequency hopping may be used within the RACH subcarriers, and the frequency location (e.g., the preamble index k as depicted in FIG. 6) of the i^{th} symbol group may be determined according to the following:

$${n}_{sc}^{RA} ( i ) = {n}_{start} + {\tilde{n}}_{SC}^{RA} ( i ) , and \\ {n}_{start} = {N}_{scoffset}^{NPRACH} + ⌊ {n}_{init} / {N}_{sc}^{RA} ⌋ {N}_{sc}^{RA} ,$$

where nₛₜₐᵣₜ is the start subcarrier index for a random access preamble transmission, nᵢₙᵢₜ may be an initial value selected by the MAC layer from {0,1, . . . ,N_{sc}^{NPRACH}−1} to determine the start subcarrier index, NA may be a ceiling for determining the start subcarrier index (e.g., N_{sc}^{RA}=12 or N_{sc}^{RA}=36), and N_{sc}^{NPRACH} is the number of subcarriers allocated to an NPRACH, for example, configured by RRC signaling and/or system information. The quantity ñ_{sc}^{RA} (i) may be a pseudo-random formula that depends on the codeword, which may be the codeword used for the start subcarrier index. For example, at the boundary between preamble repetition units—e.g., corresponding to i mod 4=0—the value of ñ_{sc}^{RA} (i) may depend on the codeword. In some cases, ñ_{sc}^{RA} (i) may depend on the frame structure used for the preamble. For a certain codeword (e.g., a codeword having all ones in binary), the UE may use the frequency hopping pattern that does not depend on the codeword.

### Example Random Access Response

In certain aspects, the RAN may send a RAR transmission via a data block (e.g., one or more transport blocks), which may include a MAC protocol data unit (PDU). The MAC PDU may carry one or more RARs, where each of the RARs may be associated with a given preamble transmission as further described herein.

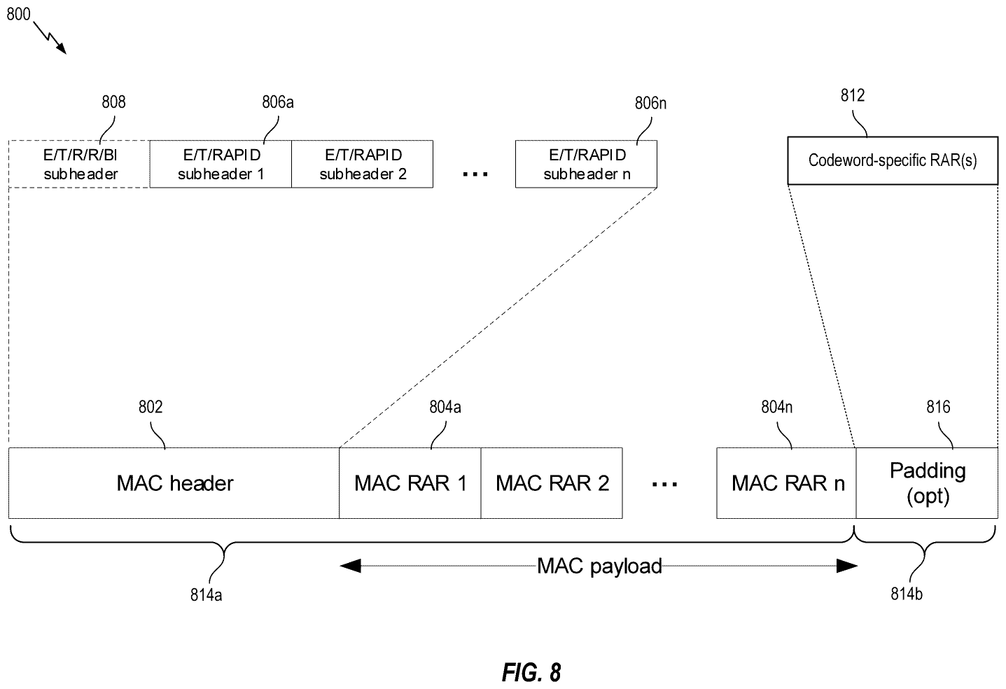

FIG. 8 is a diagram illustrating an example MAC PDU 800 for communicating (e.g., broadcasting or multicasting) one or more RARs to one or more UEs. In this example, the MAC PDU 800 may include a MAC header 802 and one or more RAR payloads 804a-n. The MAC header 802 may include one or more RAPID subheaders 806a-n, and in some cases, a backoff subheader 808. In certain aspects, the MAC PDU 800 may include one or more codeword-specific RAR(s) 812, as further described herein. The RAR payloads 804a-n may be part of a MAC payload, which may also include padding bit(s) and/or the codeword-specific RAR(s) 812 (as further described herein).

Each of the RAPID subheaders 806a-n may correspond to at least one of the RAR payloads 804a-n, for example, according to the order in which the RAPID subheaders 806a-n and the RAR payloads 804a-n are arranged in the MAC PDU 800. As an example, the first RAPID subheader 806a in the sequence of RAPID subheaders 806a-n corresponds to the first RAR payload 804a in the sequence of RAR payloads 804a-n, and so on to the last (nth) RAPID subheader 806n corresponding to the last (nth) RAR payload 806n. In certain aspects, a RAPID subheader and corresponding RAR payload may form a RAR associated with a preamble transmission, where each of the RAR payloads 804a-n may be considered a component of the RAR (e.g., a component RAR). The RAPID subheader and corresponding RAR payload may be components of a specific RAR addressed to one or more UEs.

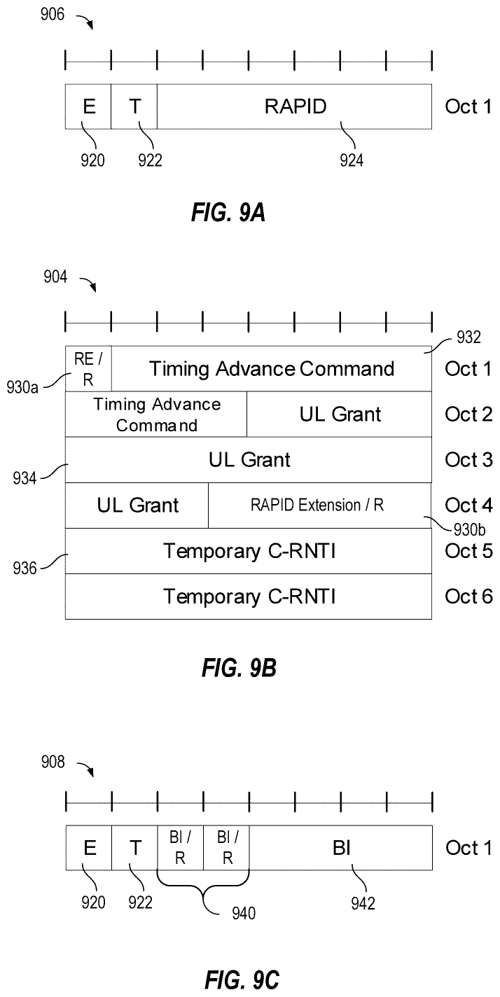

The association between a RAR and a preamble may be indicated via at least the RAPID, for example, in a RAPID subheader as further described herein with respect to FIG. 9A. For NB-IoT devices, the RAPID may correspond to at least a start subcarrier index associated with the preamble. The start subcarrier index may correspond to the subcarrier used to transmit the symbol group beginning a random access preamble transmission (e.g., the earliest symbol group in a sequence of symbol groups associated with a preamble transmission). For example, as depicted in FIG. 6, the preamble may be transmitted starting with the first symbol group 602a in a start subcarrier index 6, which may correspond to the RAPID.

In certain aspects, the MAC PDU 800 carrying the RAR(s) may be multi-compatible for different types of preambles, for example, codeword-based preamble(s) and non-codeword-based preamble(s). In some cases, the RAPID may correspond to a start subcarrier index and a codeword associated with a preamble transmission. For example, a first set of values (e.g., values 0 through 15) of the RAPID may correspond to non-codeword-based preambles (e.g., corresponding to a start subcarrier index), and a second set of values (e.g., values 16 through 63) may correspond to codeword-based preambles (e.g., corresponding to a start subcarrier index and a codeword).

In certain aspects, the MAC PDU 800 may be multi-compatible via data segmentation of the MAC PDU 800. For example, the MAC PDU 800 may include a first data portion 814a and a second data portion 814b. The first data portion 814a may include one or more first RARs (e.g., the RAPID subheaders 806a-n and the RAR payloads 804a-n) associated with non-codeword-based RACH communications, and the second data portion 812b may include one or more second RARs (e.g., the one or more codeword-specific RARs 812) associated with codeword-based RACH communications. In certain aspects, the one or more codeword-specific RARs 812 may be structured according to the first RARs, for example, having RAPID subheader(s) and RAR payload(s). For the codeword-specific RARs 812, the RAPID subheader may have a RAPID value that corresponds to the subcarrier index and the codeword used for the preamble transmission. In some cases, the one or more second RARs may include RARs that are associated with different types of preambles, such as codeword-based preambles and one or more other types of preambles (e.g., preambles for future RACH feature enhancements).

In certain aspects, the second data portion 814b may correspond to (or treated as) one or more padding bits 816 in the MAC PDU 800 by certain UE(s). For example, the UE(s) that do not support codeword-based RACH communications may ignore or refrain from decoding the padding bits 816. The presence and length of the padding bits 816 may be based on the transport block size of the transport block carrying the MAC PDU 800. For example, the transport block size may be selected to accommodate the RAPID subheaders 806a-n and the RAR payloads 804a-n in the first data portion 814a and/or the one or more codeword-specific RARs 812 in the second data portion 814b.

In certain aspects, the association between a RAR and a preamble transmission may be indicated via the RAR subheader and/or certain information in the corresponding RAR payload. For example, the RAR payload may include certain bits that may be used in combination with the RAPID to indicate a codeword-based preamble transmission.

FIGS. 9A and 9B are diagrams illustrating an example RAPID subheader 906 and an example RAR payload 904. In these examples, the various fields may be arranged in one or more octets of bits (e.g., a byte). Referring to FIG. 9A, the RAPID subheader 906 may include an extension field (E) 920, a type field (T) 922, and a RAPID field 924, for example, arranged in an octet (October 1).

The extension field 920 may be or include a flag (e.g., a bit flag) indicating if a subsequent RAPID subheader is present in the MAC PDU header. As an example, the extension field 920 may be set to “1” to indicate at least another RAPID subheader (e.g., a set of E/T/RAPID fields) follows. The extension field 920 may be set to “0” to indicate that a RAR payload (e.g., a MAC RAR), one or more padding bits, or a codeword-specific RAR starts at the next byte.

The type field 922 may be or include a flag indicating whether the subheader includes a RAPID or a Backoff Indicator. As an example, the type field 922 may be set to “O” to indicate the presence of a Backoff Indicator field in a backoff subheader, for example, as further described herein with respect to FIG. 9C. The type field 922 may be set to “1” to indicate the presence of the RAPID field in the subheader 906.

The RAPID field 924 may be used to identify a transmitted random access preamble. As an example, the size of the RAPID field 924 may be 6 bits, which may correspond to 64 values for the RAPID.

As shown in FIG. 9B, the RAR payload 904 may include one or more RAPID extension fields 930a-b (collectively RAPID extension fields 930), a timing advance command field 932, a UL grant field 934, and a temporary cell-RNTI (C-RNTI) field 936, for example, arranged in six octects (October 1-6). In some cases, the structure of the RAR payload 904 as depicted in FIG. 9B may be specified for NB-IoT communications.

The one or more RAPID extension fields 930 may be used to expand the bit space for identifying the RAPID associated with the RAPID subheader 906. For example, a combination of the RAPID field 924 and the one or more RAPID extension fields 930 may identify a specific codeword-based preamble transmission (e.g., the start subcarrier index and the codeword used for the corresponding symbol group of the preamble transmission). The one or more RAPID extension fields 930 may include one or more bits (e.g., 1-6 bits) arranged across or in one or more octets of the RAR payload 904.

As an example, a codeword-capable UE may determine the RAPID for a codeword-based preamble via an expanded RAPID space comprising the RAPID field 924 in the RAPID subheader 906 and the one or more RAPID extension fields 930 (e.g., 1-5 bits) in the corresponding RAR payload 904. In certain cases, for example, where non-codeword-based RACH communications for NB-IoT UEs may use up to 48 values for the RAPID (e.g., 0 to 47), the remaining RAPID values (48 to 63) may be used in combination with the one or more RAPID extension fields 930 for identifying a codeword-based preamble. As an example, assuming the second RAPID extension field 930b (e.g., having a size of 5 bits) is used, the expanded RAPID space may correspond to 512 values for identifying a codeword-based preamble (e.g., 2⁵×(63−47)=32×16=512 RAPID values).

In certain aspects, the one or more RAPID extension fields 930 may correspond to one or more reserved bits for non-codeword-based preambles. For example, a UE that does not support codeword-based RACH communications may ignore or refrain from interpreting the one or more RAPID extension fields 930. Thus, such an architecture for the RAR as described herein allows compatibility with (or support for responding to) multiple types of random access preambles (e.g., codeword-based preambles and non-codeword-based preambles).

The timing advance command field 932 may indicate the index value T_{A} (0, 1, 2 . . . 1282) used to control the amount of timing adjustment that the UE applies for uplink communications with the network entity. For NB-IoT UEs using a specific preamble format (e.g., preamble format 2), the timing advance command field 932 may indicate the index value T_{A} (0, 1, 2 . . . 1536). The size of the timing advance command field 932 may be 11 bits, for example.

The UL grant field 934 may indicate the resources to be used on the uplink for MSG3. For NB-IoT UEs, the size of UL grant field 934 may be 15 bits, and for other types of UEs, the size of UL grant field 934 may be 20 bits or 12 bits, for example.

The Temporary C-RNTI field 934 may indicate the temporary identity that is used by the UE during Random Access, for example, for contention resolution of MSG4. The size of the Temporary C-RNTI field 934 may be 16 bits, for example.

In certain aspects, the RAR may indicate a backoff parameter value that is specific to codeword-based RACH communications. The backoff parameter value in the RAR corresponding to the OCC-supporting UEs may be distinct from (or separate from) another backoff parameter value assigned to other types of UEs, for example. The backoff parameter value may be used to control congestion/load for random access communications, for example, depending on the densities (or occurrence of random access attempts) associated with the type of UE (e.g., OCC-supporting UEs versus other types of UEs). In some cases, the RAN may determine to treat codeword-based RACH communications differently or separately from other RACH communications in terms of the backoff parameter value, for example, due to different overload conditions between codeword-based RACH communications and other RACH communications. The RAN may adjust the backoff parameter value in response to the overload condition of the cell or RACH being accessed by UEs. For example, when the RACH is overloaded (e.g., when the RAN is receiving multiple identical preambles), the RAN may increase the backoff parameter value to delay subsequent RACH transmission from some UEs. When the RACH is underloaded (e.g., when the RAN is receiving very few identical preambles), the RAN may decrease the backoff parameter value to allow more frequent preamble transmissions.

The UE may determine a backoff time for delaying a subsequent random access transmission (e.g., MSG1) based on the backoff parameter value. For example, in cases where the UE may not receive or be unable to decode MSG2 or MSG4 in a random access procedure, the UE may retry sending a subsequent random access preamble. In certain cases, the backoff parameter value may be used in a probability formula for selecting a random backoff time for determining a delay for the subsequent random access transmission. As an example, the UE may select a random backoff time according to a uniform distribution between 0 and the backoff parameter value indicated in the RAR, and the UE may delay sending a random access preamble by the selected backoff time.

In certain aspects, the backoff subheader may be multi-compatible for codeword-based RACH communications and non-codeword-based RACH communications.

FIG. 9C is a diagram illustrating an example backoff subheader 908. In this example, the backoff subheader 908 includes the extension field 920, the type field 922, one or more backoff extension indicator fields 940, and a backoff indicator (BI) field 942, for example, arranged in an octet (October 1). In certain aspects, the extension field 920 may not be used, interpreted, or decoded for a backoff subheader. The UE may ignore or refrain from decoding the extension field 920 for the backoff subheader 908.

As described herein with respect to FIG. 9A, the type field 922 may be or include a flag indicating whether the subheader includes a RAPID or a Backoff Indicator. The type field 922 may be set to a different value from the value set for the RAPID subheader 906 in order to indicate that the given subheader includes a backoff parameter value.

The one or more backoff extension fields 940 may be used to expand the bit space for indicating the backoff parameter value for codeword-based RACH communications. For example, a combination of the BI field 942 and the one or more backoff extension fields 940 may indicate the backoff parameter value for codeword-based RACH communications. In some cases, the backoff parameter value may be determined based on the values associated with the BI field 942 and the one or more backoff extension fields 940. As an example, the one or more backoff extension fields 940 may indicate an adjustment factor or scaling factor by which the value for the BI field 942 is to be determined (e.g., multiplied, divided, added, or subtracted). The one or more backoff extension fields 940 may include one or more bits (e.g., 1-2 bits) in the octet.

In certain aspects, the one or more backoff extension fields 940 may correspond to one or more reserved bits for non-codeword-based RACH communications. For example, a UE that does not support codeword-based RACH communications may ignore or refrain from interpreting the one or more backoff extension fields 940. Thus, such an architecture for the RAR as described herein allows compatibility with (or support for handling congestion for) multiple types of random access preambles (e.g., codeword-based preambles and non-codeword-based preambles).

The BI field 942 may indicate the overload condition in the cell. The size of the BI field 942 may be or include 4 bits, for example.

In certain aspects, the RAN may send separate RAR(s) for codeword-based RACH communications, for example, as a separate RAR transmission (e.g., a separate TB for OCC-supporting UEs) or via data segmentation (e.g., in the second data portion 814b) as described herein with respect to FIG. 8. In some cases, a codeword-specific RAR may include a codeword-specific BI. For example, a backoff subheader for codeword-based RACH communications may be included in the data block carrying the RAR(s).

In certain aspects, the RAN may send scheduling (e.g., DCI) for a codeword-specific RAR transmission using a codeword-specific RA-RNTI. For example, the DCI (or a cyclic redundancy check (CRC) thereof) may be scrambled using the codeword-specific RA-RNTI, and the UE may decode (or descramble) the DCI using the RA-RNTI. The codeword-specific RA-RNTI may allow the RAN to multicast or groupcast the codeword-specific RAR to UEs supporting codeword-based communications. The UE may be configured with a codeword-specific RA-RNTI, and the UE may use the RA-RNTI to descramble a DCI message scheduling the RAR. The codeword-specific RA-RNTI may be determined using an offset assigned to codeword/OCC-supporting UEs to distinguish the codeword-specific RA-RNTI from a different RA-RNTI. As an example, for NB-IoT UEs, the RA-RNTI associated with the PRACH in which the Random Access Preamble may be transmitted, may be computed as:

$$RA - RNTI = 1 + floor ( SFN\_id / 4 ) + 256 * carrier\_id + c\_adj$$

where SFN_id is the index of the first radio frame of the specified PRACH, carrier_id is the index of the UL carrier associated with the specified PRACH, and c_adj may be an offset for codeword-based RACH communications. The carrier_id of the anchor carrier may be 0. Some UEs may be configured to monitor a certain number of RA-RNTIs (e.g., only one or two). For a specific-codeword (e.g., codeword having all ones in binary), the UE may monitor the non-codeword-based RA-RNTI, depending on the NPRACH preamble configuration (and/or RACH partitioning) supported.

### Example Codeword-Based MSG3

In certain aspects, code division multiplexing may be applied to a MSG3 transmission in a random access procedure. For example, the RAR may indicate a codeword to use for the MSG3 transmission. In cases where the MAC PDU carries RARs for codeword-based preambles and other types of preambles (for example, as described herein with respect to FIG. 8), the codeword may be indicated in a RAR payload associated with a codeword-based preamble.

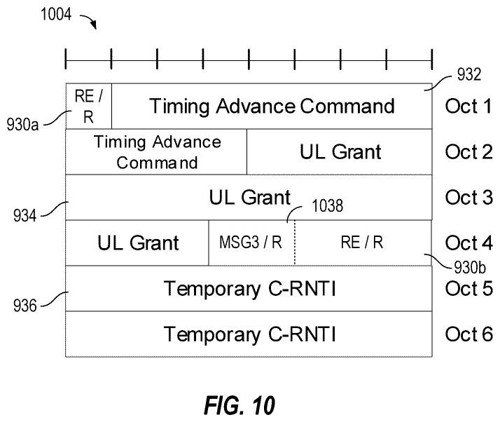

FIG. 10 is a diagram illustrating an example RAR payload 1004 indicating a codeword for a MSG3 transmission. In this example, the RAR payload 1004 may include the fields described herein with respect to FIG. 9B. The RAR payload 1004 may also include a MSG3 codeword field 1038 that indicates a codeword to be used for the MSG3 transmission. In some cases, the value of the MSG3 codeword field 1038 may be used to determine the codeword, for example, as an index value corresponding to a codeword value. As shown, the MSG3 field codeword 1038 includes two bits. In some cases, the MSG3 codeword field 1038 may include one or more bits depending on the bit(s) allocated to the RAPID extension fields 930, for example. In certain cases, the MSG3 codeword field 1038 may correspond to one or more reserved bits, which may be ignored by UEs that do not support codeword-based RACH communications.

In cases where the RAR is scheduled via a codeword-specific RA-RNTI, the RAR may have a separate MSG3 codeword field, for example, with more bits compared to the multi-compatible RAR payload 1004.

In certain cases, the subcarrier spacing field in the RAR may indicate whether MSG3 OCC multiplexing is allowed. For example, OCC-based communications may only be supported for a particular subcarrier spacing (e.g., 3.75 kHz). If the RAR provides an UL grant for the OCC-supported subcarrier spacing, such an UL grant may implicitly indicate for the UE to use OCC for the MSG3 transmission.

### Example Configurations for Codeword-Based Random Access

In certain aspects, the codeword-based RACH communications may be configured via any of various configuration levels including, for example, a common configuration, a carrier-specific configuration, a channel-specific configuration, a UE group configuration, a UE-specific configuration, etc. The configuration parameters may include any of the parameters described herein with respect to the NPRACH configuration.

In some cases, the RAN may configure UE(s) with a common codeword-based RACH configuration, which may apply across all carriers (e.g., all serving cells of a cell group) used for RACH communications. As an example, system information (e.g., a SIB associated with an anchor-carrier) may carry a common (or general) OCC-specific information element (IE), which may have configurations (including fields) that apply across all carriers (e.g., serving cells). The RAN may modify the common configuration via level-specific configurations including, for example, carrier-specific (e.g., a particular serving cell in the cell group), channel-specific, UE group-specific, and/or UE-specific. For example, certain fields may be common, whereas certain other fields (e.g., the weights to determine probabilistic RACH subcarrier sharing between OCC-supporting UEs and other UEs as described herein with respect to FIG. 7) may be carrier-specific.

In certain cases, the RAN may configure UE(s) with an OCC-specific configuration (e.g., SIB IEs and fields within such IEs) on a per (NB-IoT) carrier basis. For example, a UE may notify the RAN that the UE is capable of codeword-based RACH communications, and the RAN may configure that UE with an OCC-specific configuration associated with a particular carrier (e.g., serving cell) for NB-IoT communications.

### Example Codeword-Based Subsequent RACH Transmissions

In certain aspects, retransmissions of a preamble (e.g., subsequent preamble transmissions) may use a specific codeword for the retransmission. For example, in cases where the UE does not receive or is unable to decode MSG2 or MSG4, the UE may reattempt to communicate with RAN by reinitiating (restarting) the random access procedure with a random access preamble transmission (MSG1). The UE may select the same codeword as the initial RACH transmission, a different codeword, or a random codeword (e.g., via an independent and identically distributed random selection) for the subsequent RACH transmission. Using a different codeword or a randomly selected codeword may allow the subsequent RACH transmission to avoid using the same codeword that resulted in a RACH failure, for example, due to a codeword collision with another UE.

In certain aspects, a UE may treat a certain codeword (e.g., a codeword having all ones in a binary format) for a random access and/or RACH communication (e.g., a preamble transmission, a RAR, and/or MSG3) as though such a RACH communication is not codeword-based. For example, a preamble transmission that uses the codeword having all ones in binary may be equivalent to a non-codeword-based preamble transmission, and thus, the various codeword-based aspects described herein may not apply to that particular codeword.

Codeword-specific information (such as a RAR, RA-RNTI, backoff parameter value, BI, or the like) related to random access communications may refer to certain information that is dedicated to or specifically produced for codeword-based random access communications. For example, UE(s) that support codeword-based random access communications may be configured to use the codeword-specific information, whereas other UE(s) that do not support codeword-based random access communications may ignore or refrain from using the codeword-specific information.

### Example Operations of Entities in a Communications Network

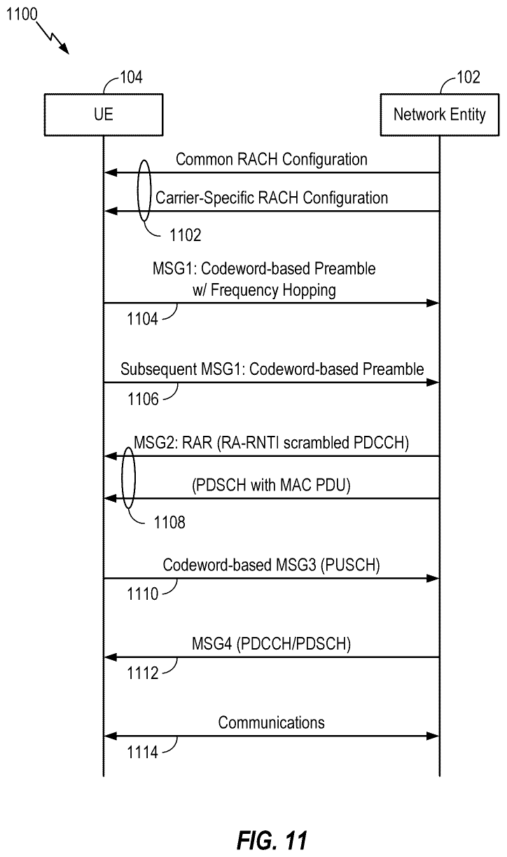

FIG. 11 depicts a process flow 1100 for communications in a network between the BS 102 (referred to in this example as a network entity) and the UE 104. In some aspects, the network entity 102 may be an example of the base station depicted and described with respect to FIGS. 1 and 3 or a disaggregated base station depicted and described with respect to FIG. 2. However, in other aspects, the UE 104 may be another type of wireless communications device, and network entity 102 may be another type of network entity or network node, such as those described herein.

At 1102, the UE 104 may receive, from the network entity 102, one or more configurations associated with codeword-based random access communications. The configuration(s) may include a common RACH configuration and/or a carrier-specific RACH configuration. As an example, the common RACH configuration may indicate or include any of the various parameters, fields, or settings described herein, such as the number of start subcarriers 712, the number of subcarriers 714, and/or the probability 716. The settings associated with the carrier-specific RACH configuration may override corresponding settings associated with the common RACH configuration. As an example, the common RACH configuration may provide a first value for the probability 716, whereas the carrier-specific RACH configuration may provide a second value for the probability 716 that modifies the first value for the respective carrier. The UE 104 may receive the configuration(s) via control signaling, such as system information, RRC signaling, MAC signaling, and/or DCI.

At 1104, the UE 104 transmits, to the network entity 102, a random access preamble (MSG1) in a RACH, such as the NPRACH, as described herein with respect to FIG. 6. The UE 104 may transmit the random access preamble using codeword-based frequency hopping as described herein. The preamble may be multiplexed using a codeword, such as a codeword associated with an orthogonal cover code (OCC). In certain aspects, the UE 104 may randomly select the codeword among a set of codewords as configured by the RAN and/or specified in certain wireless communication standards, such as the 3GPP standards for NB-IoT communications.

At 1106, the UE 104 may transmit, to the network entity 102, a subsequent random access preamble in a RACH occasion (for example, as determined based on a backoff value). As an example, in some cases, the UE 104 may not receive or be unable to decode MSG2 and/or MSG4, and in such cases, the UE 104 may reinitiate the random access procedure via a subsequent preamble transmission. In certain aspects, the UE 104 may transmit the subsequent random access preamble using a codeword as described herein with respect to retransmissions. For example, the codeword for the subsequent preamble transmission may be the same codeword used at 1104, a different codeword, or a randomly selected codeword. In certain cases, the backoff parameter value may be indicated in a RAR as described herein with respect to FIG. 9C. In some cases, a codeword-specific RAR (e.g., a RAR transmitted via a codeword-specific RA-RNTI) may indicate or include a backoff parameter value associated with codeword-based random access communications.

At 1108, the UE 104 receives, from the network entity 102, a random access response (RAR) associated with the subsequent preamble transmission. The RAR may also be referred to as MSG2. For example, the UE 104 may receive, from the network entity 102, a PDCCH transmission scrambled with an RA-RNTI. The PDCCH may carry DCI scheduling the RAR. The UE 104 may receive, from the network entity, a PDSCH transmission carrying the RAR (e.g., a MAC PDU with the RAR payload associated with the preamble) in accordance with the scheduling indicated in the DCI. The RAR may provide an UL grant for MSG3. In some cases, the RAR may be compatible for multiple types of random access communications, for example, as described herein with respect to FIGS. 8 and 9A-9C. In certain cases, the RAR may be specific to codeword-based random access communications. For example, the RA-RNTI used to the scramble the PDCCH transmission may be allocated for codeword-based random access communications, as described herein. In certain aspects, the RAR may indicate a backoff parameter value that is specific to codeword-based random access communications. In certain aspects, the RAR may indicate a codeword for the MSG3 transmission, for example, as described herein with respect to FIG. 10.

At 1110, in response to MSG2, the UE 104 transmits, to the network entity 102, MSG3 via the PUSCH in accordance with the UL grant indicated in the RAR. The MSG3 transmission may be multiplexed using the codeword as indicated in the RAR.

At 1112, the UE 104 receives, from the network entity 102, a contention resolution message (MSG4) in response to MSG3. In some cases, the MSG4 may include an RRC connection setup message in response to the RRC connection request and/or an UL grant in response to the scheduling request, for example.

At 1114, the UE 104 communicates with the network entity 102 based on the RACH communications. As an example, the UE 104 may apply any configuration for the communication link between the UE 104 and the network entity 102 as indicated or included in the RRC connection setup message. The RRC connection setup message may indicate or include various configurations, such as configuration(s) for control signaling (e.g., a PDCCH or a control resource set), PUSCH, PUCCH, PDSCH, transmit power control(s), channel state feedback reporting (e.g., CSI reporting), SRS, antenna configuration, and/or scheduling requests. In certain aspects, the configuration provided in the RRC connection setup message may facilitate the reception of subsequent configurations. In some cases, the UE 104 may transmit an UL signal in accordance with the UL grant provided in MSG4.

Those of skill in the art will understand that the process flow 1100 is an example of a codeword-based CBRA procedure. Other signaling may be used in addition to or instead of those illustrated in the process flow 1100, such as signaling associated with a CFRA procedure and/or a two-step RACH procedure, for example, as described herein with respect to FIG. 5B. Note some aspects of the process flow 1100 may be optional, such that the codeword-based random access communications described herein may involve common/carrier-specific RACH configurations (e.g., at 1102), codeword-based frequency hopping (e.g., at 1104), retransmission of a codeword-based preamble (e.g., at 1106), a RAR that indicates a codeword for MSG3 (e.g., at 1108), codeword-based MSG3 transmission (e.g., at 1110), or any combination thereof.

### Example Operations of a User Equipment

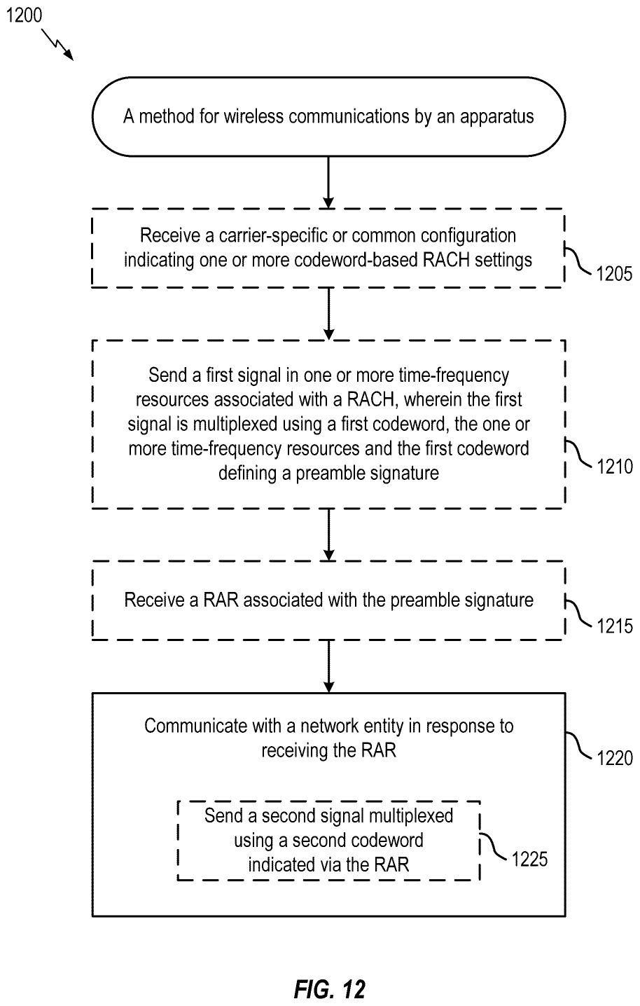

FIG. 12 shows a method 1200 for wireless communications by an apparatus, such as UE 104 of FIGS. 1 and 3.

Method 1200 may begin at block 1205 with receiving a carrier-specific or common configuration indicating one or more codeword-based RACH settings, for example, as described herein with respect to FIG. 11.

Method 1200 may then proceed to block 1210 with sending a first signal in one or more time-frequency resources associated with a RACH, wherein the first signal is multiplexed using a first codeword, the one or more time-frequency resources and the first codeword defining a preamble signature. In certain aspects, the one or more time-frequency resources may be arranged according to a frequency hopping pattern based at least in part on the first codeword, for example, as described herein with respect to FIG. 6. As an example, the one or more time-frequency resources associated with the RACH may be or include subcarrier(s) and/or symbol group(s) in the RACH.

Method 1200 may then proceed to block 1215 with receiving a RAR associated with the preamble signature, for example, as described herein with respect to FIGS. 8, 9A-9C, and/or 10.

Method 1200 then proceeds to block 1220 with communicating with a network entity in response to receiving the RAR, for example, as described herein with respect to FIG. 11. In certain aspects, block 12205 includes block 1225 where the apparatus sends a second signal (e.g., MSG3) multiplexed using a second codeword indicated via the RAR.

In certain aspects, the first signal comprises a preamble signal and one or more repetitions associated with the preamble signal. In certain aspects, the one or more repetitions comprise one or more PRUs; and the frequency hopping pattern indicates one or more subcarrier locations associated with each of the PRUs.

In certain aspects, block 1215 includes receiving a data block (e.g., a transport block or MAC PDU) comprising a RAR header and a RAR payload associated with the RAR header, the first codeword being indicated via (i) a field in the RAR header and (ii) one or more bits in the RAR payload, and the second codeword being indicated via a field in the RAR payload, for example, as described herein with respect to FIG. 10.

In certain aspects, the RAR comprises a field indicating the second codeword. For example, the RAR may be a codeword-specific RAR as described herein.

In certain aspects, the RAR indicates a subcarrier spacing used for codeword-based RACH communications, and wherein the subcarrier spacing indicates that the codeword-based RACH communications are permitted for the second signal.

In certain aspects, block 1205 includes receiving a carrier-specific configuration indicating one or more codeword-based RACH settings associated with a carrier, and block 1210 includes sending the first signal in accordance with the carrier-specific configuration, the carrier being associated with the one or more time-frequency resources. For example, one or more frequency resource of the one or more time-frequency resources may be in the carrier.

In certain aspects, block 1205 includes receiving a common configuration indicating one or more first codeword-based RACH settings that apply across a plurality of carriers, and block 1210 includes sending the first signal in accordance with the common configuration.

In certain aspects, block 1205 includes receiving a carrier-specific configuration indicating one or more second codeword-based RACH settings associated with a carrier, and block 1210 includes sending the first signal in accordance with the common configuration and the carrier-specific configuration. In certain aspects, the one or more second codeword-based RACH settings override any of the one or more first codeword-based RACH settings for the carrier. The second RACH settings may modify the first RACH settings for the carrier. For example, a first value for a probability indicated in the carrier-specific configuration may replace a second value for the probability indicated in the common configuration, when communicating via the carrier associated with the carrier-specific configuration. In some cases, a carrier-specific setting (e.g., parameter, field, value, etc.) may be prioritized over a corresponding common setting.

In certain aspects, method 1200 further includes sending a retransmission associated with the first signal in the RACH, wherein the retransmission is multiplexed with a second codeword, for example, as described herein with respect to the subsequent preamble transmission depicted in FIG. 11. The retransmission may be a subsequent preamble transmission relative to the preamble transmission at block 1205.

In certain aspects, the RACH comprises an NPRACH. In certain aspects, the apparatus comprises an IoT device.

In certain aspects, the first codeword is associated with code division multiplexing. In certain aspects, the first codeword is associated with an orthogonal cover code.

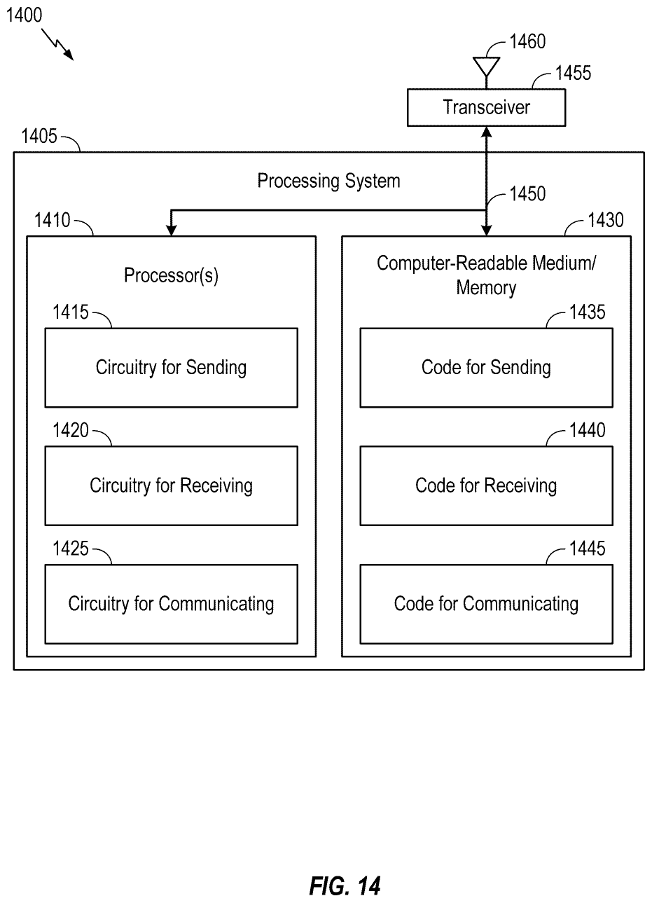

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure. Note that any operations illustrated with dashed lines indicates that that operation may be optional or an alternative.

### Example Operations of a Network Entity

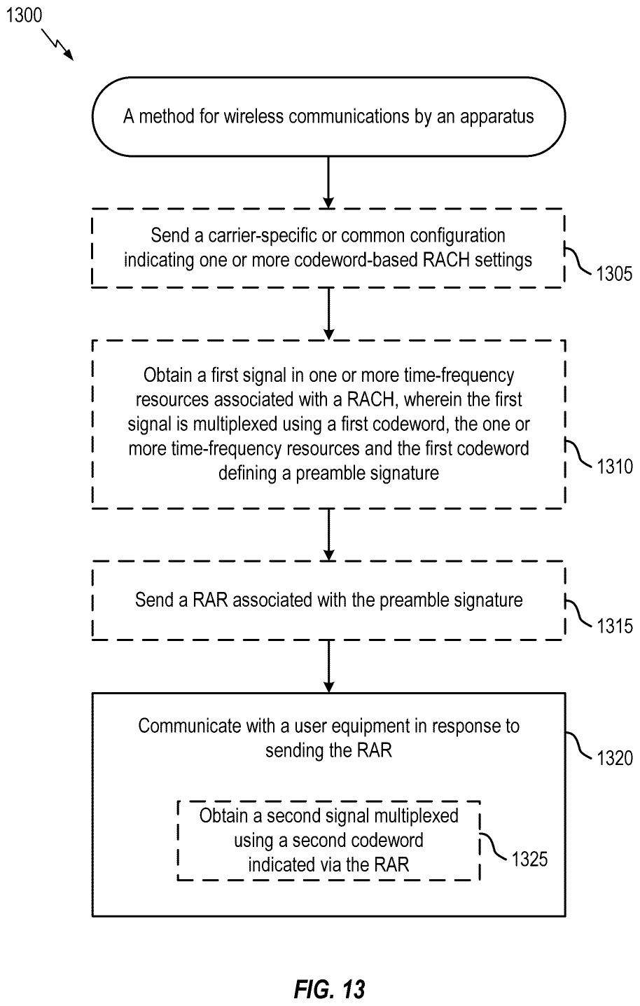

FIG. 13 shows a method 1300 for wireless communications by an apparatus, such as BS 102 of FIGS. 1 and 3, or a disaggregated base station as discussed with respect to FIG. 2.

Method 1300 may begin at block 1305 with sending a carrier-specific or common configuration indication one or more codeword-based RACH settings.

Method 1300 may then proceed to block 1310 with obtaining a first signal in one or more time-frequency resources associated with a RACH, wherein the first signal is multiplexed using a first codeword, the one or more time-frequency resources and the first codeword defining a preamble signature. In certain aspects, the one or more time-frequency resources may be arranged according to a frequency hopping pattern based at least in part on the first codeword, for example, as described herein with respect to FIG. 6.

Method 1300 may then proceed to block 1315 with sending a RAR associated with the preamble signature, for example, as described herein with respect to FIGS. 8, 9A-9C, and/or 10.

Method 1300 may then proceed to block 1320 with communicating with a user equipment in response to sending the RAR, for example, as described herein with respect to FIG. 11. In certain aspects, block 1320 includes block 1325 where the apparatus obtains a second signal (e.g., MSG3) multiplexed using a second codeword indicated via the RAR.

In certain aspects, the first signal comprises a preamble signal and one or more repetitions associated with the preamble signal.

In certain aspects, the one or more repetitions comprise one or more PRUs; and the frequency hopping pattern indicates one or more subcarrier locations associated with each of the PRUs.

In certain aspects, block 1315 includes sending a data block (e.g., a transport block or MAC PDU) comprising a RAR header and a RAR payload associated with the RAR header, the first codeword being indicated via at least one of (i) a field in the RAR header or (ii) one or more bits in the RAR payload, and the second codeword being indicated via a field in the RAR payload, for example, as described herein with respect to FIG. 10.

In certain aspects, the RAR comprises a field indicating the second codeword. For example, the RAR may be a codeword-specific RAR as described herein.

In certain aspects, the RAR indicates a subcarrier spacing used for codeword-based RACH communications, and wherein the subcarrier spacing indicates that the codeword-based RACH communications are permitted for the second signal.

In certain aspects, block 1305 includes sending a carrier-specific configuration indicating one or more codeword-based RACH settings associated with a carrier, and block 1310 includes obtaining the first signal in accordance with the carrier-specific configuration, the carrier being associated with the one or more time-frequency resources. For example, one or more frequency resource of the one or more time-frequency resources may be in the carrier.

In certain aspects, block 1305 includes sending a common configuration indicating one or more first codeword-based RACH settings applying across a plurality of carriers, and block 1310 includes obtaining the first signal in accordance with the common configuration.

In certain aspects, block 1305 includes obtaining a carrier-specific configuration indicating one or more second codeword-based RACH settings associated with a carrier, and block 1310 includes obtaining the first signal in accordance with the common configuration and the carrier-specific configuration. In certain aspects, the one or more second codeword-based RACH settings override any of the one or more first codeword-based RACH settings for the carrier, for example, as described herein with respect to FIG. 12.

In certain aspects, method 1300 further includes obtaining a retransmission associated with the first signal in the RACH, wherein the retransmission is multiplexed with a second codeword.

In certain aspects, the RACH comprises an NPRACH.

In certain aspects, the first codeword is associated with code division multiplexing. In certain aspects, the first codeword is associated with an orthogonal cover code.

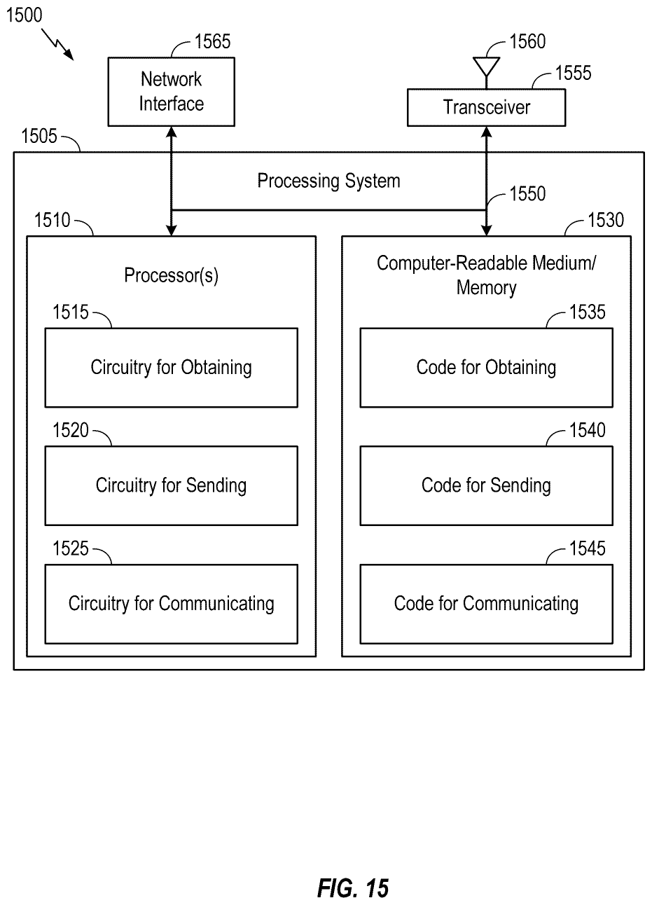

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure. Note that any operations illustrated with dashed lines indicates that that operation may be optional or an alternative.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to a transceiver 1455 (e.g., a transmitter and/or a receiver). The transceiver 1455 is configured to transmit and receive signals for the communications device 1400 via an antenna 1460, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code or processor-executable instructions) that when executed by the one or more processors 1410, enable and cause the one or more processors 1410 to perform the method 1200 described with respect to FIG. 12, or any aspect related to it, including any additional operations described in relation to FIG. 12. Note that reference to a processor performing a function of communications device 1400 may include one or more processors performing that function of communications device 1400, such as in a distributed fashion.

In the depicted example, computer-readable medium/memory 1430 stores code for sending 1435, code for receiving 1440, and code for communicating 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry for sending 1415, circuitry for receiving 1420, and circuitry for communicating 1425. Processing with circuitry 1415-1425 may enable and cause the communications device 1400 to perform the method 1200 described with respect to FIG. 12, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1455 and/or antenna 1460 of the communications device 1400 in FIG. 14, and/or one or more processors 1410 of the communications device 1400 in FIG. 14. Means for communicating, receiving or obtaining may include the transceivers 354, antenna(s) 352, receive processor 358, and/or controller/processor 380 of the UE 104 illustrated in FIG. 3, transceiver 1455 and/or antenna 1460 of the communications device 1400 in FIG. 14, and/or one or more processors 1410 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to a transceiver 1555 (e.g., a transmitter and/or a receiver) and/or a network interface 1565. The transceiver 1555 is configured to transmit and receive signals for the communications device 1500 via an antenna 1560, such as the various signals as described herein. The network interface 1565 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code or processor-executable instructions) that when executed by the one or more processors 1510, enable and cause the one or more processors 1510 to perform the method 1300 described with respect to FIG. 13, or any aspect related to it, including any additional operations described in relation to FIG. 13. Note that reference to a processor of communications device 1500 performing a function may include one or more processors of communications device 1500 performing that function, such as in a distributed fashion.

In the depicted example, the computer-readable medium/memory 1530 stores code for obtaining 1535, code for sending 1540, and code for communicating 1545. Processing of the code 1535-1545 may enable and cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry for obtaining 1515, circuitry for sending 1520, and circuitry for communicating 1525. Processing with circuitry 1515-1525 may enable and cause the communications device 1500 to perform the method 1300 described with respect to FIG. 13, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1555 and/or antenna 1560 of the communications device 1500 in FIG. 15, and/or one or more processors 1510 of the communications device 1500 in FIG. 15. Means for communicating, receiving or obtaining may include the transceivers 332, antenna(s) 334, receive processor 338, and/or controller/processor 340 of the BS 102 illustrated in FIG. 3, transceiver 1555 and/or antenna 1560 of the communications device 1500 in FIG. 15, and/or one or more processors 1510 of the communications device 1500 in FIG. 15.

### Example Clauses

### Implementation Examples are Described in the Following Numbered Clauses:

Clause 1: A method for wireless communications by an apparatus, comprising: sending a first signal in one or more time-frequency resources associated with a RACH, wherein the first signal is multiplexed using a first codeword, the one or more time-frequency resources and the first codeword defining a preamble signature, and the one or more time-frequency resources being arranged according to a frequency hopping pattern based at least in part on the first codeword; receiving a RAR associated with the preamble signature; and communicating with a network entity in response to receiving the RAR.

Clause 2: A method for wireless communications by an apparatus, comprising: sending a first signal in one or more time-frequency resources associated with a RACH, wherein the first signal is multiplexed using a first codeword, the one or more time-frequency resources and the first codeword defining a preamble signature; receiving a RAR associated with the preamble signature; and communicating with a network entity in response to receiving the RAR.

Clause 3: The method of Clause 2, wherein the one or more time-frequency resources are arranged according to a frequency hopping pattern based at least in part on the first codeword.

Clause 4: The method of any of Clauses 1-3, wherein the first signal comprises a preamble signal and one or more repetitions associated with the preamble signal.

Clause 5: The method of Clause 4, wherein: the one or more repetitions comprise one or more PRUs; and the frequency hopping pattern indicates one or more subcarrier locations associated with each of the PRUs.

Clause 6: The method of any one of Clauses 1-5, wherein communicating with the network entity comprises: sending a second signal multiplexed using a second codeword indicated via the RAR.

Clause 7: The method of Clause 6, wherein receiving the RAR comprises: receiving a data block comprising a RAR header and a RAR payload associated with the RAR header, the first codeword being indicated via at least one of (i) a field in the RAR header or (ii) one or more bits in the RAR payload, and the second codeword being indicated via a field in the RAR payload.

Clause 8: The method of Clause 6, wherein the RAR comprises a field indicating the second codeword.

Clause 9: The method of Clause 6, wherein the RAR indicates a subcarrier spacing used for codeword-based RACH communications, and wherein the subcarrier spacing indicates that the codeword-based RACH communications are permitted for the second signal.

Clause 10: The method of any one of Clauses 1-9, further comprising: receiving a carrier-specific configuration indicating one or more codeword-based RACH settings associated with a carrier, wherein sending the first signal comprises sending the first signal in accordance with the carrier-specific configuration, the carrier being associated with the one or more time-frequency resources.

Clause 11: The method of any one of Clauses 1-10, further comprising: receiving a common configuration indicating one or more first codeword-based RACH settings applying across a plurality of carriers, wherein sending the first signal comprises sending the first signal in accordance with the common configuration.

Clause 12: The method of Clause 11, further comprising: receiving a carrier-specific configuration indicating one or more second codeword-based RACH settings associated with a carrier, wherein sending the first signal comprises sending the first signal in accordance with the common configuration and the carrier-specific configuration.

Clause 13: The method of Clause 12, wherein the one or more second codeword-based RACH settings override any of the one or more first codeword-based RACH settings for the carrier.

Clause 14: The method of any one of Clauses 1-13, further comprising sending a retransmission associated with the first signal in the RACH, wherein the retransmission is multiplexed with a second codeword.

Clause 15: The method of any one of Clauses 1-14, wherein the RACH comprises an NPRACH.

Clause 16: The method of any one of Clauses 1-15, wherein the apparatus comprises an IoT device.

Clause 17: The method of any one of Clauses 1-16, wherein the first codeword is associated with code division multiplexing.

Clause 18: The method of any one of Clauses 1-17, wherein the first codeword is associated with an orthogonal cover code.

Clause 19: A method for wireless communications by an apparatus, comprising: obtaining a first signal in one or more time-frequency resources associated with a RACH, wherein the first signal is multiplexed using a first codeword, the one or more time-frequency resources and the first codeword defining a preamble signature, the one or more time-frequency resources being arranged according to a frequency hopping pattern based at least in part on the first codeword; sending a RAR associated with the preamble signature; and communicating with a user equipment in response to sending the RAR.

Clause 20: A method for wireless communications by an apparatus, comprising: obtaining a first signal in one or more time-frequency resources associated with a RACH, wherein the first signal is multiplexed using a first codeword, the one or more time-frequency resources and the first codeword defining a preamble signature; sending a RAR associated with the preamble signature; and communicating with a user equipment in response to sending the RAR.

Clause 21: The method of Clause 20, wherein the one or more time-frequency resources are arranged according to a frequency hopping pattern based at least in part on the first codeword.

Clause 22: The method of Clause 19-21, wherein the first signal comprises a preamble signal and one or more repetitions associated with the preamble signal.

Clause 23: The method of Clause 22, wherein: the one or more repetitions comprise one or more PRUs; and the frequency hopping pattern indicates one or more subcarrier locations associated with each of the PRUs.

Clause 24: The method of any one of Clauses 19-23, wherein communicating with the user equipment comprises: obtaining a second signal multiplexed using a second codeword indicated via the RAR.

Clause 25: The method of Clause 24, wherein sending the RAR comprises: sending a data block comprising a RAR header and a RAR payload associated with the RAR header, the first codeword being indicated via at least one of (i) a field in the RAR header or (ii) one or more bits in the RAR payload, and the second codeword being indicated via a field in the RAR payload.

Clause 26: The method of Clause 24, wherein the RAR comprises a field indicating the second codeword.

Clause 27: The method of Clause 24, wherein the RAR indicates a subcarrier spacing used for codeword-based RACH communications, and wherein the subcarrier spacing indicates that the codeword-based RACH communications are permitted for the second signal.

Clause 28: The method of any one of Clauses 19-27, further comprising: sending a carrier-specific configuration indicating one or more codeword-based RACH settings associated with a carrier, wherein obtaining the first signal comprises obtaining the first signal in accordance with the carrier-specific configuration, the carrier being associated with the one or more time-frequency resources.

Clause 29: The method of any one of Clauses 19-28, further comprising: sending a common configuration indicating one or more first codeword-based RACH settings applying across a plurality of carriers, wherein obtaining the first signal comprises obtaining the first signal in accordance with the common configuration.

Clause 30: The method of Clause 29, further comprising: obtaining a carrier-specific configuration indicating one or more second codeword-based RACH settings associated with a carrier, wherein obtaining the first signal comprises obtaining the first signal in accordance with the common configuration and the carrier-specific configuration.

Clause 31: The method of Clause 30, wherein the one or more second codeword-based RACH settings override any of the one or more first codeword-based RACH settings for the carrier.

Clause 32: The method of any one of Clauses 19-31, further comprising obtaining a retransmission associated with the first signal in the RACH, wherein the retransmission is multiplexed with a second codeword.

Clause 33: The method of any one of Clauses 19-32, wherein the RACH comprises an NPRACH.

Clause 34: The method of any one of Clauses 19-33, wherein the first codeword is associated with code division multiplexing.

Clause 35: The method of any one of Clauses 19-34, wherein the first codeword is associated with an orthogonal cover code.

Clause 36: One or more apparatuses, comprising: one or more memories; and one or more processors coupled to the one or more memories, the one or more processors being configured to cause the one or more apparatuses to perform a method in accordance with any one of clauses 1-35.

Clause 37: One or more apparatuses, comprising means for performing a method in accordance with any one of clauses 1-35.

Clause 38: One or more non-transitory computer-readable media comprising executable instructions that, when executed by one or more processors of one or more apparatuses, cause the one or more apparatuses to perform a method in accordance with any one of clauses 1-35.

Clause 39: One or more computer program products embodied on one or more computer-readable storage media comprising code for performing a method in accordance with any one of clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
send a first signal in one or more time-frequency resources associated with a random access channel (RACH), wherein the first signal is multiplexed using a first codeword, the one or more time-frequency resources and the first codeword defining a preamble signature;
receive a random access response (RAR) associated with the preamble signature; and
communicate with a network entity in response to receiving the RAR.

2. The apparatus of claim 1, wherein:
the one or more time-frequency resources are arranged according to a frequency hopping pattern based at least in part on the first codeword,
the first signal comprises a preamble signal and one or more repetitions associated with the preamble signal, and
the first codeword is associated with an orthogonal cover code.

3. The apparatus of claim 2, wherein:
the one or more repetitions comprise one or more preamble repetition units (PRUs); and
the frequency hopping pattern indicates one or more subcarrier locations associated with each of the PRUs.

4. The apparatus of claim 1, wherein to communicate with the network entity, the one or more processors are configured to cause the apparatus to: send a second signal multiplexed using a second codeword indicated via the RAR.

5. The apparatus of claim 4, wherein to receive the RAR, the one or more processors are configured to cause the apparatus to: receive a data block comprising a RAR header and a RAR payload associated with the RAR header, the first codeword being indicated via at least one of (i) a field in the RAR header or (ii) one or more bits in the RAR payload, and the second codeword being indicated via a field in the RAR payload.

6. The apparatus of claim 1, wherein:
the one or more processors are configured to cause the apparatus to receive a carrier-specific configuration indicating one or more codeword-based RACH settings associated with a carrier; and
to send the first signal, the one or more processors are configured to cause the apparatus to send the first signal in accordance with the carrier-specific configuration, the carrier being associated with the one or more time-frequency resources.

7. The apparatus of claim 1, wherein:
the one or more processors are configured to cause the apparatus to receive a common configuration indicating one or more first codeword-based RACH settings applying across a plurality of carriers; and
to send the first signal, the one or more processors are configured to cause the apparatus to send the first signal in accordance with the common configuration.

8. The apparatus of claim 7, wherein:
the one or more processors are configured to cause the apparatus to receive a carrier-specific configuration indicating one or more second codeword-based RACH settings associated with a carrier; and
to send the first signal, the one or more processors are configured to cause the apparatus to send the first signal in accordance with the common configuration and the carrier-specific configuration.

9. The apparatus of claim 8, wherein the one or more second codeword-based RACH settings override any of the one or more first codeword-based RACH settings for the carrier.

10. The apparatus of claim 1, wherein the one or more processors are configured to cause the apparatus to send a retransmission associated with the first signal in the RACH, wherein the retransmission is multiplexed with a second codeword.

11. An apparatus configured for wireless communications, comprising:
one or more memories; and
one or more processors coupled to the one or more memories, the one or more processors being configured to cause the apparatus to:
obtain a first signal in one or more time-frequency resources associated with a random access channel (RACH), wherein the first signal is multiplexed using a first codeword, the one or more time-frequency resources and the first codeword defining a preamble signature;
send a random access response (RAR) associated with the preamble signature; and
communicate with a user equipment in response to sending the RAR.

12. The apparatus of claim 11, wherein:
the one or more time-frequency resources are arranged according to a frequency hopping pattern based at least in part on the first codeword,
the first signal comprises a preamble signal and one or more repetitions associated with the preamble signal, and
the first codeword is associated with an orthogonal cover code.

13. The apparatus of claim 12, wherein:
the one or more repetitions comprise one or more preamble repetition units (PRUs); and
the frequency hopping pattern indicates one or more subcarrier locations associated with each of the PRUs.

14. The apparatus of claim 11, wherein to communicate with the user equipment, the one or more processors are configured to cause the apparatus to: obtain a second signal multiplexed using a second codeword indicated via the RAR.

15. The apparatus of claim 14, wherein to send the RAR, the one or more processors are configured to cause the apparatus to: send a data block comprising a RAR header and a RAR payload associated with the RAR header, the first codeword being indicated via at least one of (i) a field in the RAR header or (ii) one or more bits in the RAR payload, and the second codeword being indicated via a field in the RAR payload.

16. The apparatus of claim 11, wherein:
the one or more processors are configured to cause the apparatus to send a carrier-specific configuration indicating one or more codeword-based RACH settings associated with a carrier; and
to obtain the first signal, the one or more processors are configured to cause the apparatus to obtain the first signal in accordance with the carrier-specific configuration, the carrier being associated with the one or more time-frequency resources.

17. The apparatus of claim 11, wherein:
the one or more processors are configured to cause the apparatus to send a common configuration indicating one or more first codeword-based RACH settings applying across a plurality of carriers; and
to obtain the first signal, the one or more processors are configured to cause the apparatus to obtain the first signal in accordance with the common configuration.

18. The apparatus of claim 17, wherein:
the one or more processors are configured to cause the apparatus to obtain a carrier-specific configuration indicating one or more second codeword-based RACH settings associated with a carrier; and
to obtain the first signal, the one or more processors are configured to cause the apparatus to obtain the first signal in accordance with the common configuration and the carrier-specific configuration.

19. The apparatus of claim 11, wherein the one or more processors are configured to cause the apparatus to obtain a retransmission associated with the first signal in the RACH, wherein the retransmission is multiplexed with a second codeword.

20. A method for wireless communications by an apparatus, comprising:
sending a first signal in one or more time-frequency resources associated with a random access channel (RACH), wherein the first signal is multiplexed using a first codeword, the one or more time-frequency resources and the first codeword defining a preamble signature;
receiving a random access response (RAR) associated with the preamble signature; and
communicating with a network entity in response to receiving the RAR.
